(19) United States
(12) Patent Application Publication
(10) Pub. No.: US 2019/0195324 A1
(43) Pub. Date: Jun. 27, 2019

(54) TRANSMISSION DEVICE

(71) Applicant: Tsubakimoto Chain Co., Osaka (JP)

(72) Inventor: Yoshikazu Ema, Osaka-shi (JP)

(73) Assignee: Tsubakimoto Chain Co., Osaka (JP)

(21) Appl. No.: 16/227,259

(22) Filed: Dec. 20, 2018

(30) Foreign Application Priority Data
Dec. 25, 2017 (JP) 2017-248238

(51) Int. Cl. F16H 25/22; F16H 57/04

(52) U.S. Cl. CPC F16H 25/2204; F16H 2025/209; F16H 57/0435; F16H 57/0498

(57) ABSTRACT

A transmission device comprises an input shaft, a screw shaft extending in a direction orthogonal to the input shaft, a transmission member which forms an annular shape surrounding the screw shaft and rotates around the screw shaft by a power which is input from the input shaft, and a nut which is mounted to the screw shaft and rotates by the power transmitted from the transmission member. The nut is disposed on an axis orthogonal to the screw shaft and the input shaft.

### CROSS-REFERENCE TO RELATED APPLICATIONS

This Nonprovisional application claims priority under 35 U.S.C. § 119(a) on Patent Application No. 2017-248238 filed in Japan on Dec. 25, 2017, the entire contents of which are hereby incorporated by reference.

### FIELD

The present invention relates to a transmission device that transmits power.

### BACKGROUND AND SUMMARY

In related art, there has been proposed a jack equipped with a screw shaft, a nut mounted to the screw shaft, a worm shaft, and a worm wheel which transmits the power from the worm shaft to the nut. The nut is fixed in an axial direction, and the screw shaft moves in the axial direction by the rotation of the worm shaft. A mounting portion is provided on the screw shaft, and by attaching an object to the mounting portion, it is possible to move the object in a linear direction.

In the jack, there was a problem that the nut and the worm wheel are arranged in the axial direction of the screw shaft, and are increased in size in the axial direction of the screw shaft.

The present disclosure has been made in view of such circumstances, and an object thereof is to provide a transmission device that can prevent an increase in size in the axial direction of the screw shaft.

According to an aspect of disclosure, there is provided a transmission device comprising: an input shaft; a screw shaft extending in a direction orthogonal to the input shaft; a transmission member which forms an annular shape surrounding the screw shaft and rotates around the screw shaft by a power which is input from the input shaft; and a nut which is mounted to the screw shaft and rotates by the power transmitted from the transmission member, wherein the nut is disposed on an axis orthogonal to the screw shaft and the input shaft.

The above and further objects and features will more fully be apparent from the following detailed description with accompanying drawings.

### BRIEF DESCRIPTION OF THE DRAWINGS

FIG. 1 is a perspective view schematically illustrating a transmission device.

FIG. 2 is a plan view schematically illustrating the transmission device.

FIG. 3 is a vertical cross-sectional view schematically illustrating the transmission device.

FIG. 4 is an explanatory cross-sectional view describing a mounting method of the transmission device when the transmission device is suspended and used.

FIG. 5 is an example of a graph showing a relation between a rotational speed of a ball screw shaft of the transmission device having different inter-core distances and an allowable load to the ball screw shaft.

FIG. 6 is a perspective view schematically illustrating an example of a transmission device with a partially modified configuration.

FIG. 7 is an explanatory cross-sectional view describing a mounting method of the transmission device when the transmission device is suspended and used.

FIG. 8 is a perspective view schematically illustrating another example of a transmission device with a partially modified configuration.

### DETAILED DESCRIPTION OF NON-LIMITING EXAMPLE EMBODIMENTS

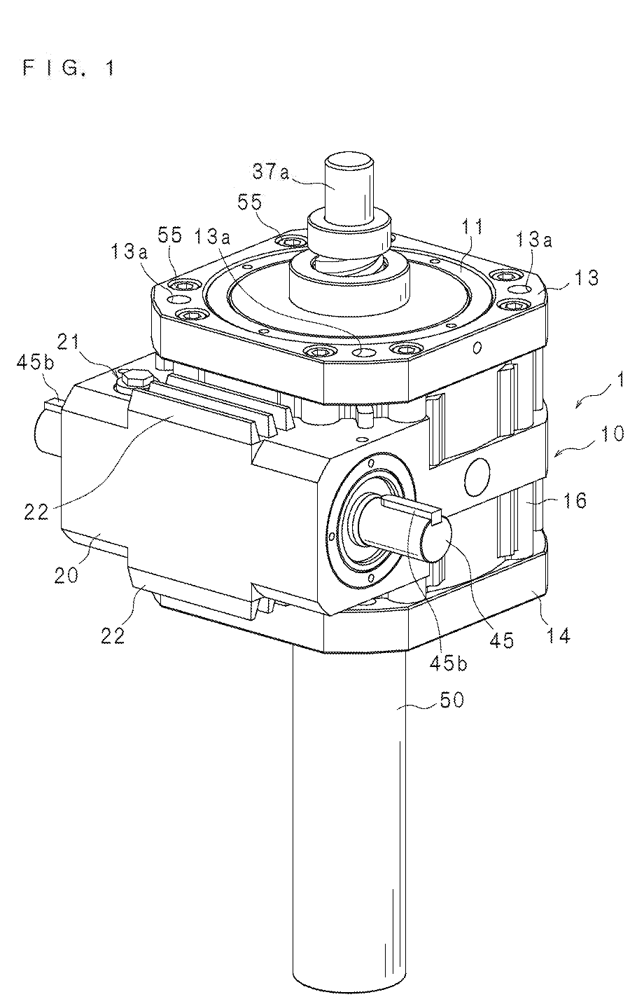

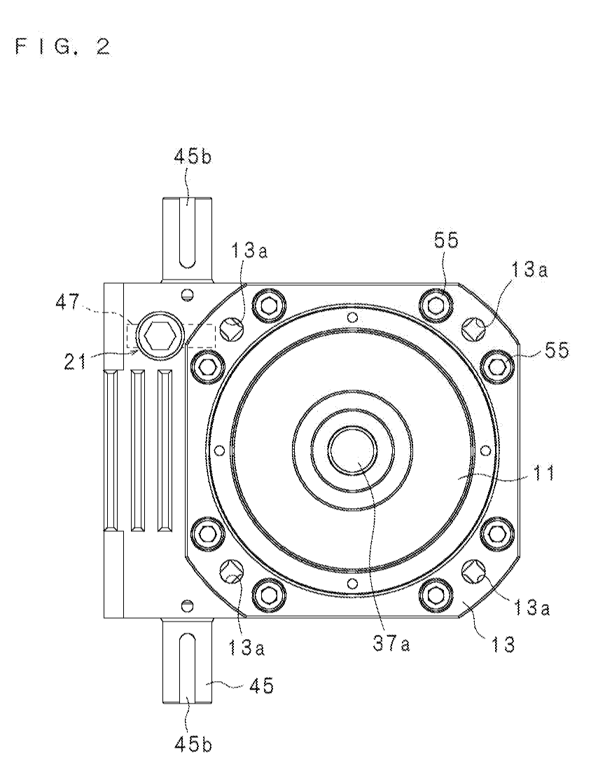

Hereinafter, the present invention will be described with reference to the drawings illustrating a transmission device according to an embodiment. FIG. 1 is a perspective view schematically illustrating the transmission device, and FIG. 2 is a plan view schematically illustrating the transmission device. The transmission device includes a case 1 that accommodates a worm 45a, a worm wheel 46 (a transmission member), a nut 38, and a ball screw shaft 37, which will be described later. The case 1 has a rectangular parallelepiped first case 10, and a second case 20 protruding from one surface of the first case 10. The worm wheel 46 corresponds to the transmission member.

The second case 20 has an elongated rectangular parallelepiped shape and extends parallel to the one surface of the first case 10. A longitudinal dimension of the second case 20 is substantially the same as a width of the first case 10, and both end portions of the second case 20 do not protrude outward beyond the first case 10.

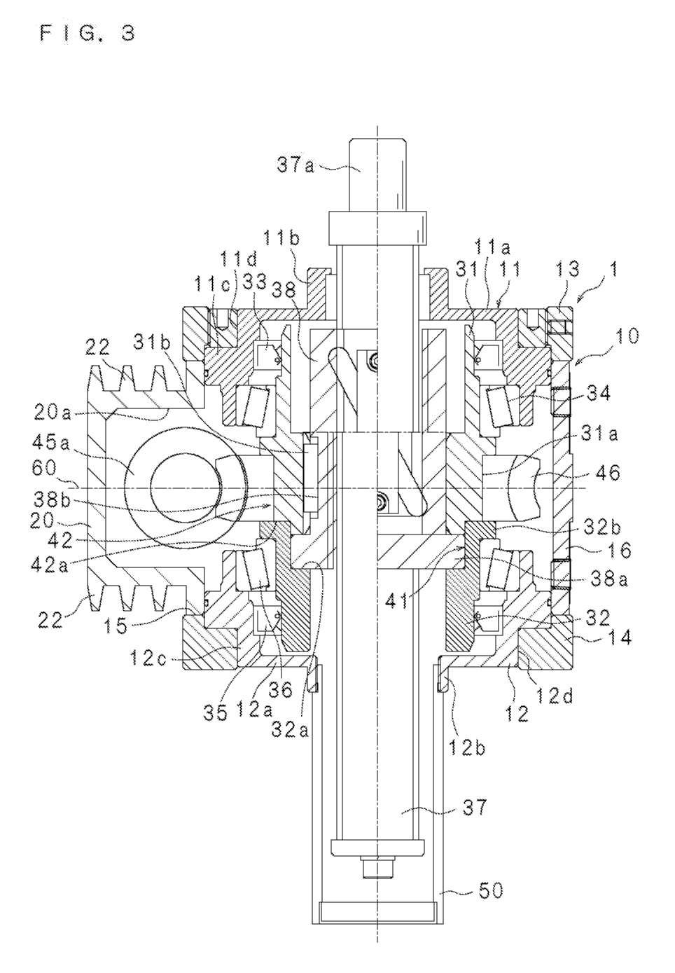

FIG. 3 is a vertical cross-sectional view schematically illustrating the transmission device. In a connecting portion between the first case 10 and the second case 20, openings 15 and 20a are formed in the first case 10 and the second case 20, respectively. A portion of the second case 20 having the opening 20a is disposed inside the opening 15 of the first case 10, and internal spaces of the first case 10 and the second case 20 are continued. The first case 10 and the second case 20 are integrally formed.

The first case 10 includes a first bearing holder 11 and a second bearing holder 12 that face each other. The first bearing holder 11 includes an annular portion 11a, a first cylindrical portion 11b protruding in the axial direction from an inner circumferential portion of the annular portion 11a, and a second cylindrical portion 11c protruding from an outer circumferential portion of the annular portion 11a in a direction opposite to the first cylindrical portion 11b. The protruding end portion of the second cylindrical portion 11e protrudes outward in the radial direction into a flange shape, and a groove 11d having an L-shaped cross section is annularly formed on the outer circumferential surface of the second cylindrical portion 11c.

The second bearing holder 12 includes an annular portion 12a, a first cylindrical portion 12b protruding in the axial direction from the inner circumferential portion of the annular portion 12a, and a second cylindrical portion 12c protruding from the outer circumferential portion of the annular portion 12a in the direction opposite to the first cylindrical portion 12b. The protruding end portion of the second cylindrical portion 12c protrudes outward in the radial direction into a flange shape, and a groove 12d having an L-shaped cross section is annularly formed on the outer circumferential surface of the second cylindrical portion 12c. The first bearing holder 11 and the second bearing holder 12 are arranged coaxially with the second cylindrical portions 11c and 12c facing each other, respectively. A bottomed cylindrical screw cover 50 is fitted to the first cylindrical portion 12b of the second bearing holder 12. An end portion of the screw cover 50 on the side opposite to the bottom surface is inserted into the first cylindrical portion 12b.

In the first bearing holder 11, a cylindrical first wheel hub 31 is disposed coaxially inside the protruding end portion of the second cylindrical portion 11c. The first wheel hub 31 extends toward the second bearing holder 12, and an extending end portion thereof is disposed to be closer to the second bearing holder 12 than the second cylindrical portion 11c. An annular oil seal 33 and a bearing 34 are juxtaposed in the axial direction between the second cylindrical portion 11c and the first wheel hub 31. The bearing 34 is disposed to be closer to the second bearing holder 12 than the oil seal 33.

In the second bearing holder 12, a cylindrical second wheel hub 32 is disposed coaxially inside the protruding end portion of the second cylindrical portion 12c. The second wheel hub 32 extends toward the first bearing holder 11, and an extending end portion thereof is disposed to be closer to the first bearing holder 11 than the second cylindrical portion 12c. An annular oil seal 35 and a bearing 36 are juxtaposed in the axial direction between the second cylindrical portion 12c and the second wheel hub 32. The bearing 36 is disposed to be closer to the first bearing holder 11 than the oil seal 35. An axial distance between the two bearings 34 and 36 is smaller than outer diameters of the bearings 34 and 36. The outer diameters of the two bearings 34 and 36 are substantially the same, and the inner diameters of the two bearings 34 and 36 are also substantially the same.

Extending end portions of each of the first wheel hub 31 and the second wheel hub 32 are butted against each other. A seal bond 42a is applied to a portion in which the first wheel hub 31 and the second wheel hub 32 are butted against each other. Instead of the seal bond 42a, a seal member such as an O ring may be interposed in the butted portion. The oil seals 33 and 35 and the seal bond 42a correspond to a sealant. A groove 31a having an L-shaped cross section extending in a circumferential direction is formed on the outer circumferential surface of the extending end portion of the first wheel hub 31. The groove 31a opens toward outer side of the first wheel hub 31 in a radial direction and toward the second wheel hub 32. An annular protruding portion 32b protruding outward in the radial direction is formed at the extending end portion of the second wheel hub 32. A second groove 42 having a U-shaped cross section, which opens toward outer side in the radial direction and extends in the circumferential direction, is formed by the groove 31a and the protruding portion 32b. The worm wheel 46 is fitted to the second groove 42 having the U-shaped cross section. The second groove 42 having the U-shaped cross section and the worm wheel 46 are fitted to each other. The first wheel hub 31 and the second wheel hub 32 are connected to each other by a connecting member, for example, a bolt 55.

A groove 32a having an L-shaped cross section extending in the circumferential direction is formed on the inner circumferential surface of the extending end portion of the second wheel hub 32. The groove 32a opens toward inner side of the second wheel hub 32 in the radial direction and toward the first wheel hub 31. The outer circumferential surface of the groove 32a in the radial direction is disposed outside the inner circumferential surface of the first wheel hub 31 in the radial direction. Therefore, the first wheel hub 31 side of the groove 32a is blocked by the end surface of the first wheel hub 31. A first groove 41 having a U-shaped cross section, which opens toward inner side in the radial direction and extends in the circumferential direction, is formed by the groove 32a and the end surface of the first wheel hub 31.

A ball screw shaft 37 is disposed inside the first wheel hub 31 and the second wheel hub 32. One end portion of the ball screw shaft 37 protrudes from the first cylindrical portion 11b of the first bearing holder 11. A mounting portion 37a for mounting an object is provided at the one end portion of the ball screw shaft 37. The mounting portion 37a has fine screws. The other end portion of the ball screw shaft 37 protrudes from the second wheel hub 32 and is accommodated in the screw cover 50.

A nut 38 is mounted to the ball screw shaft 37. A rolling elements, for example, a ball, is provided between the ball screw shaft 37 and the nut 38. A ball screw mechanism is constituted by the ball screw shaft 37, the nut 38, the ball, and the circulation component, and the ball circulates, for example, by a return tube type. The circulation type of the ball in the ball screw mechanism is not limited to the return tube type, and it may be, for example, a frame type, an end cap type, an end deflector type or a middle deflector type. Although it is also conceivable to use a trapezoidal screw instead of the ball screw mechanism, the ball screw mechanism has higher transmission efficiency and higher positional accuracy than the trapezoidal screw.

A flange 38a is formed at one end portion of the nut 38. The flange 38a is fitted to the first groove 41 having a U-shaped cross section, and is axially interposed by the first wheel hub 31 and the second wheel hub 32. A key 31b is formed on the inner circumferential surface of the first wheel hub 31. A key groove 38b is formed on the outer circumferential surface of the nut 38, and the key 31b of the first wheel hub 31 is fitted to the key groove 38b. The nut 38, the first wheel hub 31, the second wheel hub 32, and the worm wheel 46 are separate components.

A first mounting board 13 having an annular shape is detachably mounted to the groove 11d of the first bearing holder 11. The first mounting board 13 has an inner ring part and an outer ring part, the inner ring part is provided in the groove 11d of the first bearing holder 11, and the outer ring part slightly protrudes in the axial direction and is provided along the outer circumferential surface of the first bearing holder 11. In the outer ring part, a plurality of screw holes 13a is arranged at equal intervals in the circumferential direction.

A second mounting board 14 having an annular shape is detachably mounted to the groove 12d of the second bearing holder 12. The outer circumferential portion of the second mounting board 14 slightly protrudes in the axial direction and is provided along the outer circumferential surface of the second bearing holder 12. A plurality of screw holes (not illustrated) is disposed on the outer circumferential portion of the second mounting board 14 at equal intervals in the circumferential direction. A side surface portion 16 is provided between the outer ring part of the first mounting board 13 and the outer circumferential portion of the second mounting board 14 to surround the worm wheel 46. The opening 15 is provided on the side surface portion 16, and the second case 20 is integrally mounted to the opening 15.

An input shaft 45 is accommodated in the second case 20. The input shaft 45 extends in a direction orthogonal to the ball screw shaft 37. Both end portions of the input shaft 45 protrude from the second case 20, and keys 45b are formed at both end portions of the input shaft 45. A worm 45a is formed at the central part of the input shaft 45 in the axial direction. The worm 45a is engaged with the worm wheel 46. As illustrated in FIG. 3, the nut 38 is disposed on an axis 60 orthogonal to the ball screw shaft 37 and the input shaft 45.

A key 45b of the input shaft 45 is inserted into a key groove of a drive source (not illustrated), and the drive source is driven. The input shaft 45 rotates and the worm 45a rotates. The worm wheel 46 engaged with the worm 45a rotates, the first wheel hub 31 and the second wheel hub 32 rotate around the axis of themselves, and the nut 38 rotates around the axis of itself. Since the flange 38a of the nut 38 is fitted into the first groove 41 having a U-shaped cross section, it does not move in the axial direction. By the rotation of the nut 38, the ball screw shaft 37 moves in the axial direction. By movement of the ball screw shaft 37 in the axial direction, the object mounted to the mounting portion 37a can be moved.

Lubricating oil is injected into the second case 20 in order to smoothly rotate the worm 45a and the worm wheel 46. Grease is applied to the ball screw shaft 37 in order to smoothly rotate the nut 38 and the ball screw shaft 37. As described above, since the oil seals 33 and 35 and the seal bond 42a are provided, the lubricating oil is prevented from entering the inside of the first wheel hub 31 or the second wheel hub 32, that is, the nut 38 and the ball screw shaft 37.

A pressure regulating valve 21 is provided in the second case 20. A shielding ring 47 into which the input shaft 45 is inserted is provided inside the second case 20. The shielding ring 47 is disposed to face the pressure regulating valve 21. Even when the pressure regulating valve 21 is opened, the shielding ring 47 prevents the lubricating oil from flowing out from the pressure regulating valve 21. The shielding ring 47 is an example of a shielding portion that prevents the outflow of the lubricating oil, and a shielding plate facing the pressure regulating valve 21 may be provided instead of the shielding ring 47. Radiating fins 22 are provided on the outer circumferential surface of the second case 20.

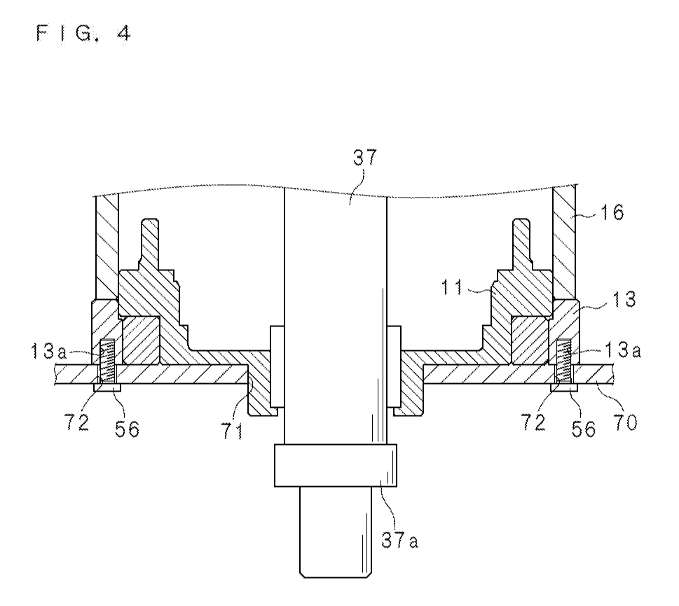

FIG. 4 is an explanatory cross-sectional view describing a mounting method of the transmission device when the transmission device is suspended and used. The transmission device is mounted, for example, as follows. A mounting hole 71 is formed in an object 70, and a diameter of the mounting hole 71 is smaller than an inner diameter of the first mounting board 13. First, a penetration hole 72 corresponding to the screw hole 13a of the first mounting board 13 is formed in the object 70. Further, the mounting portion 37a is inserted into the mounting hole 71 from above, the first mounting board 13 is put around the mounting hole 71, and the screw 56 is inserted into the penetration hole 72 from the lower side, and is fastened to the screw hole 13a of the first mounting board 13.

In the case where the transmission device is installed on the object 70 with the mounting portion 37a facing upward, the screw cover 50 may be inserted into the mounting hole 71, the second mounting board 14 may be put around the mounting hole 71, and the screw 56 may be inserted into the penetration hole 72 from the lower side and fastened to a screw hole of the second mounting board 14.

In the transmission device according to the embodiment, the ball screw shaft 37 and the input shaft 45 are disposed so as to be orthogonal to each other, and the nut 38 is disposed on the axis 60 orthogonal to the ball screw shaft 37 and the input shaft 45. Accordingly, the nut 38 and the input shaft 45 are disposed at the same position in the axial direction of the ball screw shaft 37. Therefore, it is possible to prevent the transmission device from becoming large in the axial direction of the ball screw shaft 37.

Since the nut 38 is provided between the ball screw shaft 37 and the worm wheel 46, a distance (hereinafter, referred to as an inter-core distance) between the center of the worm wheel 46 and the center of the worm 45a increases. Therefore, even when the transmission capacity increases and the input rotational speed increases, it is easy to ensure the necessary transmission capacity.

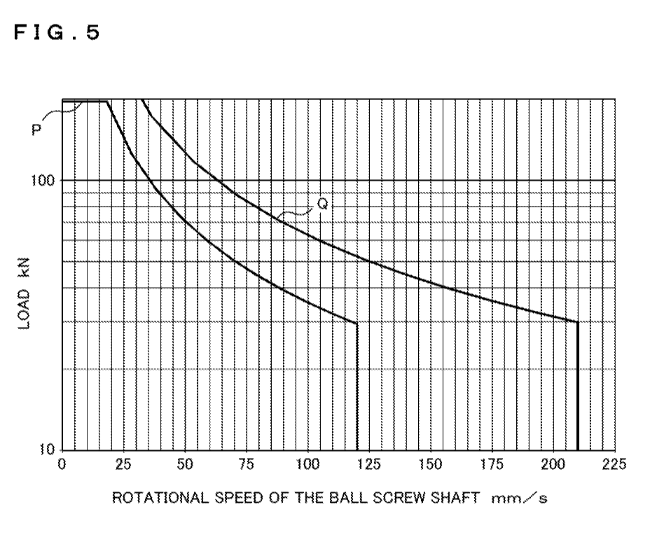

FIG. 5 is an example of a graph showing a relation between the rotational speed of the ball screw shaft 37 of the transmission device having different inter-core distances and an allowable load to the ball screw shaft 37. In FIG. 5, the scale of the load is expressed in logarithm conversion. P illustrates a graph of a transmission device having a predetermined inter-core distance, and Q illustrates a graph of a transmission device having an inter-core distance greater than the predetermined inter-core distance of P. As shown in FIG. 5, the magnitude of the allowable load with respect to the rotational speed at Q is larger than the magnitude of the allowable load with respect to the rotational speed at P.

Further, by sandwiching the flange 38a formed on the nut 38 in the axial direction, even when the transmission device is suspended and used, that is, when the transmission device is used with the mounting portion 37a facing downward, a force in the same direction acts on the nut 38 and the ball screw shaft 37. That is, when a downward pulling force is applied to the ball screw shaft 37, since the flange 38a of the nut 38 is sandwiched between the first wheel hub 31 and the second wheel hub 32, the downward pulling force also acts on the nut 38.

In a case where the nut 38 does not have the flange 38a and the nut 38 comes into contact with, for example, the first bearing holder 11, when the transmission device is suspended and used, compression force is applied to the nut 38. In this case, the directions of the forces acting on the nut 38 and the ball screw shaft 37 are different from each other, and a difference in stress acting on the nut 38 and the ball screw shaft 37 easily increases.

In the embodiment, even if the transmission device is suspended and used, since the force in the same direction acts on the ball screw shaft 37 and the nut 38, the difference in stress acting on the nut 38 and the ball screw shaft 37 becomes smaller, as compared to a case where the force acts on the ball screw shaft 37 and the nut 38 in the different directions.

Also, by inserting the flange 38a into the first groove 41 having the U-shaped cross section, fitting by spigot joint is achieved, and the accuracy of centering can be improved. Further, by inserting the worm wheel 46 into the second groove 42 having the U-shaped cross section, fitting by spigot joint is achieved, and the accuracy of centering can be improved.

Further, by mounting the first mounting board 13 and the second mounting board 14 to the object 70, the transmission member can be mounted to the desired object 70.

Further, after the penetration hole 72 corresponding to the screw hole 13a is formed in the object 70, a screw is inserted into the penetration hole 72 and coupled with the screw hole 13a, and the transmission device is fixed to the object 70. Since the plurality of screw holes 13a is arranged around the axis of the ball screw shaft 37, it is easy to set the mounting position of the transmission device around the axis of the ball screw shaft 37 at a desired position. By providing the shielding portion, the lubricating liquid is suppressed from leaking from the pressure regulating valve 21.

Further, by providing the oil seals 33 and 35 and the seal bond 42a, the ball screw shaft 37 and the nut 38 using the grease can be separated from the worm 45a and the worm wheel 46 using the lubricating oil.

An axial distance between the bearings 34 and 36 is smaller than the diameters of the bearings 34 and 36. For this reason, large bearings 34 and 36 are used to extend the life of the bearings 34 and 36 and achieve miniaturization in the axial direction.

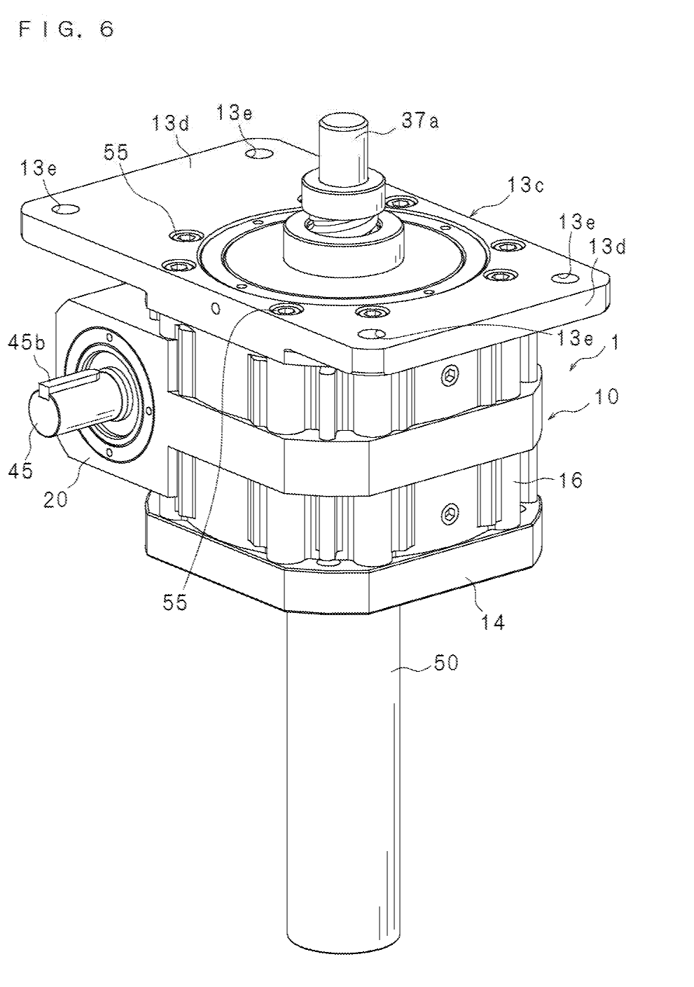

FIG. 6 is a perspective view schematically illustrating an example of a transmission device with a partially modified configuration. As illustrated in FIG. 6, a first mounting board 13c having a protruding portion 13d protruding outward from the side surface portion 16 or the second case 20 in the radial direction may be used. Since the first mounting board 13c having no protruding portion 13d is detachably mounted, it can be easily replaced with the first mounting board 13c having the protruding portion 13d. In the protruding portion 13d, a plurality of insertion holes 13e into which the screws 56 are inserted is aligned in the circumferential direction of the ball screw shaft 37.

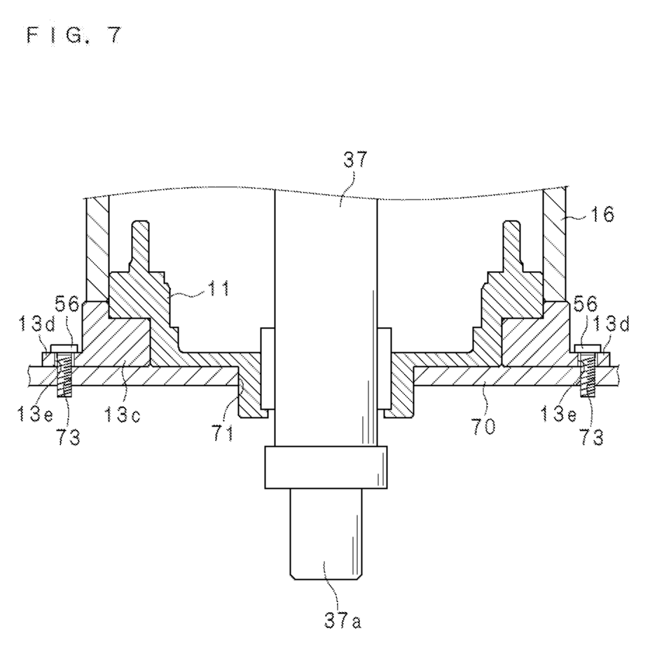

FIG. 7 is an explanatory cross-sectional view describing a mounting method of the transmission device when the transmission device is suspended and used. The transmission device is mounted, for example, as follows. First, a screw hole 73 corresponding to the insertion hole 13e of the first mounting board 13c is formed in the object 70. Further, the mounting portion 37a is inserted into the mounting hole 71 from above, the first mounting board 13c is put around the mounting hole 71, and the screw 56 is inserted into the insertion hole 13e from the upper side, and fastened to the screw hole 73 of the object 70. In the transmission device having no protruding portion 13d, the screw 56 is inserted from the lower side. However, by providing the protruding portion 13d, the screw 56 can be inserted from the upper side, and the transmission device can be easily mounted.

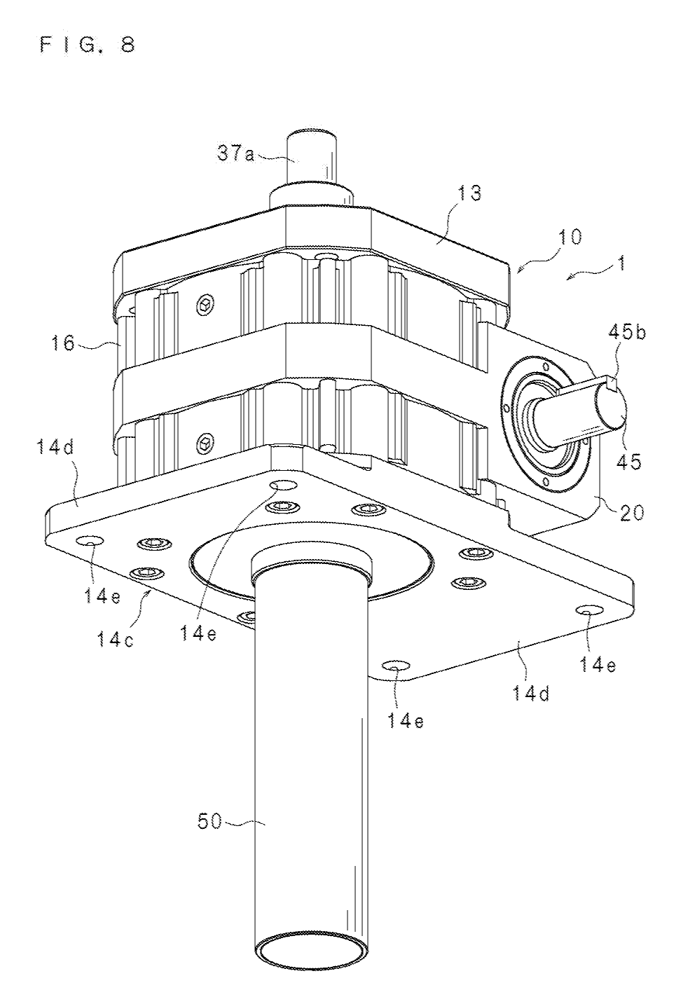

FIG. 8 is a perspective view schematically illustrating another example of the transmission device with a partially modified configuration. As illustrated in FIG. 8, a second mounting board 14c having a protruding portion 14d protruding outward from the side surface portion 16 or the second case 20 in the radial direction may be used. In the protruding portion 14d of the second mounting board 14c, a plurality of insertion holes 14e into which the screws 56 are inserted is aligned in the circumferential direction of the ball screw shaft 37. When mounting the transmission device, the screw 56 can be inserted into the insertion hole 14e of the protruding portion 14d of the second mounting board 14c from the upper side, and can be fastened to the screw hole 73 of the object 70.

It is to be noted that, as used herein and in the appended claims, the singular forms “a”, “an”, and “the” include plural referents unless the context clearly dictates otherwise. It should be understood that the embodiments disclosed herein are illustrative and non-restrictive in every respect. The technical features described in the examples may be combined with one another, while all changes that fall within metes and bounds of the claims, or equivalence of such metes and bounds thereof are intended to be embraced by the scope of the present invention.

What is claimed is:

1. A transmission device, comprising:
an input shaft;
a screw shaft extending in a direction orthogonal to the input shaft;
a transmission member which forms an annular shape surrounding the screw shaft and rotates around the screw shaft by a power which is input from the input shaft; and
a nut which is mounted to the screw shaft and rotates by the power transmitted from the transmission member,
wherein the nut is disposed on an axis orthogonal to the screw shaft and the input shaft.

2. The transmission device according to claim 1, wherein a flange is formed on the nut, and
the transmission device further comprises a hub which sandwiches the flange in an axial direction of the nut and transmits power from the transmission member to the nut.

3. The transmission device according to claim 2, wherein the hub has a cylindrical shape, and
a first groove into which the flange is inserted is formed on an inner circumferential surface of the hub.

4. The transmission device according to claim 3, wherein a second groove into which the transmission member is inserted is formed on an outer circumferential surface of the hub.

5. The transmission device according to claim 2, further comprising:
a plurality of bearings which supports the hub and juxtaposed in the axial direction of the screw shaft,
wherein an axial distance between the bearings is smaller than diameters of the bearings.

6. The transmission device according to claim 1, further comprising:
a case which accommodates the screw shaft, the nut, the transmission member, and the input shaft; and
a mounting board which mounts the case to an object.

7. The transmission device according to claim 6, wherein a plurality of screw holes is aligned around an axis of the screw shaft on the mounting board.

8. The transmission device according to claim 6, wherein a pressure regulating valve is provided on an outer surface of the case, and
a shielding portion which faces the pressure regulating valve to prevent outflow of the lubricating liquid is provided inside the case.

9. The transmission device according to claim 1, wherein the input shaft has a worm,
the transmission member has a worm wheel, and
a seal material is provided between the worm and the worm wheel and between the screw shaft and the nut.
